(19) United States
(12) Patent Application Publication
(10) Pub. No.: US 2022/0214932 A1
(43) Pub. Date: Jul. 7, 2022

(54) METHODS, DEVICES AND COMPUTER STORAGE MEDIA FOR INTER-MINI PROGRAM PLATFORM COMMUNICATION

(71) Applicant: Shanghai Lianshang Network Technology Co., Ltd., Shanghai (CN)

(72) Inventor: Yinglin Cui, Shanghai (CN)

(73) Assignee: Shanghai Lianshang Network Technology Co., Ltd., Shanghai (CN)

(21) Appl. No.: 17/595,383

(22) PCT Filed: Mar. 4, 2020
(86) PCT No.: PCT/CN2020/077695

§ 371 Date: Nov. 15, 2021

(30) Foreign Application Priority Data
Mar. 4, 2019 (CN) 201910160826.7

(51) Int. Cl. G06F 9/54

(52) U.S. Cl. CPC G06F 9/541

(57) ABSTRACT

The present disclosure provides a method, a device, and a computer storage medium for inter-mini program platform communication. The method comprises: transmitting, by a first mini program platform, launch data to a second mini program platform, wherein the launch data comprises information on a host application in which the first mini program platform is hosted and information on the first mini program platform; receiving verification data returned by the second mini program platform, wherein the verification data comprises information on a host application in which the second mini program platform is hosted and information on the second mini program platform; determining a set of application programming interfaces to be used according to the verification data; and communicating with the second mini program platform using the determined set of application programming interfaces.

### TECHNICAL FIELD

The present invention relates to computer applications, and particularly relates to a method, a device and a computer storage medium for inter-mini program platform communication.

### BACKGROUND

This section is intended to provide background or context for the embodiments of the present invention as set forth in the claims. The description herein shall not be considered as the prior art by virtue of its inclusion in this section.

A mini program is a type of application that can be used without downloading and installing, which runs in an environment provided by a host application. Currently, a mini program platform is integrated into a single host application. However, if mini program platforms are integrated into multiple host applications of a same user equipment at the same time, the mini program platforms cannot communicate with each other.

### SUMMARY

In view of this, the present invention provides a method, device and computer storage medium for inter-mini program platform communication to solve the problem that the mini program platforms cannot communicate with each other when the mini program platforms are integrated into multiple host applications of a same user equipment at the same time.

The technical solutions are specifically provided as follows.

In a first aspect, the present invention provides a method for inter-mini program platform communication. The method comprises:

transmitting, by a first mini program platform, launch data to a second mini program platform, wherein the launch data comprises information on a host application in which the first mini program platform is hosted and information on the first mini program platform;

receiving verification data returned by the second mini program platform, wherein the verification data comprises information on a host application in which the second mini program platform is hosted and information on the second mini program platform;

determining a set of application programming interfaces to be used according to the verification data; and

communicating with the second mini program platform using the determined set of application programming interfaces.

According to a preferred embodiment of the present invention, the launch data further comprises a launch reason.

According to a preferred embodiment of the present invention, the information on the host application comprises identification information of the host application;

and the information on the mini program platform comprises type information and version information of the mini program platform.

According to a preferred embodiment of the present invention, determining the set of application programming interfaces to be used according to the verification data comprises:

determining a set of application programming interfaces corresponding to a minimal version out of a version of a set of application programming interfaces corresponding to the first mini program platform and a version of a set of application programming interfaces corresponding to the second mini program platform.

According to a preferred embodiment of the present invention, determining the set of application programming interfaces to be used according to the verification data further comprises:

pulling the set of application programming interfaces corresponding to the minimal version from a mini program open platform.

According to a preferred embodiment of the present invention, the communicating comprises:

transmitting, by the first mini program platform, to the second mini program platform, information for querying whether it is ready;

starting data communication with the second mini program platform after receiving response information from the second mini program platform.

According to a preferred embodiment of the present invention, the data communication comprises:

passing first data with an invoked application programming interface; or

passing an access path to second data in the invoked application programming interface;

wherein data amount of the first data is less than data amount of the second data.

In a second aspect, a method for inter-mini program platform communication is provided. The method comprises:

receiving, by a second mini program platform, launch data transmitted by a first mini program platform, wherein the launch data comprises information on a host application in which the first mini program platform is hosted and information on the first mini program platform;

returning verification data to the first mini program platform, wherein the verification data comprises information on a host application in which the second mini program platform is hosted and information on the second mini program platform;

determining a set of application programming interfaces to be used according to the launch data; and

communicating with the first mini program platform using the determined set of application programming interfaces.

According to a preferred embodiment of the present invention, the launch data further comprises a launch reason.

According to a preferred embodiment of the present invention, the method further comprises:

performing, by the second mini program platform, verification with the launch data, and returning verification data to the first mini program platform after determining to accept the communication.

According to a preferred embodiment of the present invention, the information on the host application comprises identification information of the host application; and

the information on the mini program platform comprises type information and version information of the mini program platform.

According to a preferred embodiment of the present invention, determining the set of application programming interfaces to be used according to the verification data comprises:

determining a set of application programming interfaces corresponding to a minimal version out of a version of a set of application programming interfaces corresponding to the first mini program platform and a version of a set of application programming interfaces corresponding to the second mini program platform.

According to a preferred embodiment of the present invention, determining the set of application programming interfaces to be used according to the verification data further comprises:

pulling the set of application programming interfaces corresponding to the minimal version from a mini program open platform.

According to a preferred embodiment of the present invention, the communicating comprises:

receiving, by the second mini program platform, information transmitted by the first mini program platform for querying whether it is ready;

starting data communication with the first mini program platform after transmitting response information to the first mini program platform.

According to a preferred embodiment of the present invention, the data communication comprises:

passing first data with an invoked application programming interface; or

passing an access path to second data in the invoked application programming interface;

wherein data amount of the first data is less than data amount of the second data.

In a third aspect, the present invention provides a device. The device comprises:

one or more processors; and

a storage means for storing one or more programs,

wherein the one or more programs, when executed by the one or more processors, cause the one or more processors to implement the above-mentioned methods.

In a fourth aspect, the present invention provides a storage medium comprising computer-executable instructions, wherein the computer-executable instructions are executed by a processor of a computer to implement the above-mentioned methods.

As seen from the above technical solutions, in the present invention, the mini program platforms accomplish a handshake for launch through the exchange of the launch data and the verification data, and then determine a set of application programming interfaces based on the verification data or the launch data, and communicate with each other using the determined set of application programming interfaces. The problem that the mini program platforms cannot communicate with each other when they are integrated into multiple host applications of the same user equipment at the same time is thus solved.

### DESCRIPTIONS OF THE DRAWINGS

FIG. 1 is a flowchart of a method for inter-mini program platform discovery provided by the embodiments of the present invention;

FIG. 2 is a flowchart of a method for inter-mini program platform communication provided by the embodiments of the present invention; and

FIG. 3 shows a block diagram of an exemplary computer system/server suitable for implementing the embodiments of the present invention.

### DETAILED EMBODIMENTS

To make the objects, technical solutions, and advantages of the present invention clearer, the present invention will be described in detail in conjunction with the accompanying drawings and specific embodiments below.

To facilitate understanding of the embodiments of the present invention, several concepts involved in the embodiments of the present invention are explained.

A mini program platform provides an application programming interface for a mini program to run in a host application, and the mini program runs in the host application via the mini program platform.

A host application is an application into which the mini program platform is integrated, and an environment in which a mini program runs is provided by the host application.

The above-described mini program, mini program platform and host application are all located at a user equipment.

A mini program open platform is usually located at a server and is responsible for maintaining APIs (application programming interfaces) of mini program platforms.

A host application is installed on and runs on any user equipment, which includes but is not limited to: smart mobile terminals, smart home devices, network devices, wearable devices, smart medical devices, personal computers (PCs) and so on. Smart mobile devices may comprise, for example, mobile phones, tablet computers, laptops, personal digital assistants (PDA), Internet-capabled vehicles and so on. The smart home devices may comprise smart home electric appliances, such as smart TVs, smart speakers, etc. The network devices may comprise, for example, switches, wireless APs, servers and so on. The wearable devices may comprise, for example, smart watches, smart glasses, smart bracelets, virtual reality devices, augmented reality devices, mixed reality devices (i.e., devices which may support both virtual reality and augmented reality), and so on.

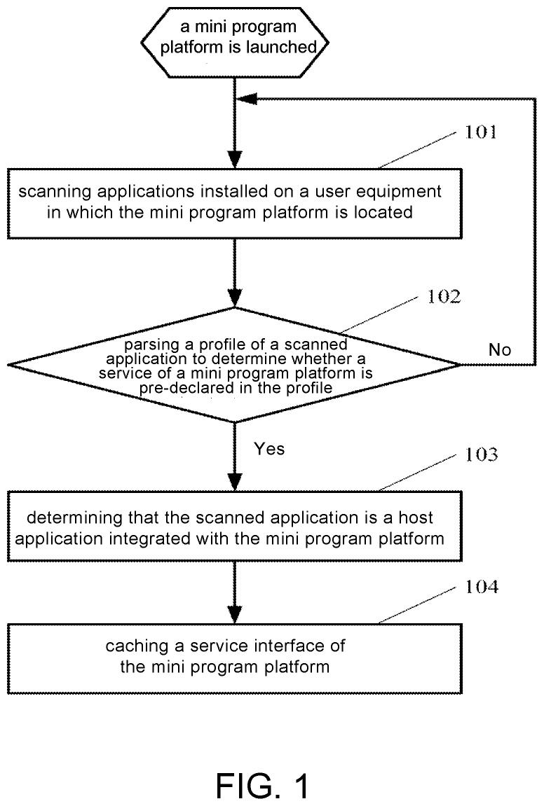

Communication among mini program platforms is based on the discovery (i.e., awareness) among the mini program platforms. A discovery procedure among mini program platforms is described with reference to embodiments herein at first. FIG. 1 is a flowchart of a method for inter-mini program platform discovery provided by the embodiments of the present invention. As shown in FIG. 1, the method mainly comprises the following steps.

At 101, when a mini program platform is launched, it scans applications installed on a user equipment where the mini program platform is located.

The mini program platform is usually launched along with the host application. The mini program platform is either launched by default when the host application is launched, or triggered and launched by a specific application scenario after its host application is launched, or triggered and launched by a person after its host application is launched.

When the mini program platform is launched, it scans applications installed locally on the user equipment where the mini program platform is located, for example, scans all application installation packages one by one.

Alternatively, in addition to triggering execution of the discovery procedure when the mini program platform is launched, other triggering ways which can be used are not excluded, such as triggering, by a specific event, the mini program platform to initiate the discovery procedure.

At 102, a profile of a scanned application is parsed to determine whether a service of a mini program platform is pre-declared in the profile. And if so, the method proceeds to 103; otherwise, the mini program platform continues to scan other applications until the scanning is complete.

When the mini program platform is integrated into a host application, the service of the mini program platform will be declared in a profile for the host application. For example, the service of the mini program platform may be declared in a manifest file of the host application. In the embodiments of the present invention, the service of the mini program platform may be declared with a preset naming mechanism. Each type of mini program platform may be configured in a uniform naming mechanism. For example, the service of the mini program platform may be named in the following format:

com.platform.XXXX.service,

wherein XXXX may be identification information of the host application, such as a package name of the host application.

Of course, various types of mini program platforms may also be configured with their own naming mechanisms. However, a mini program platform may acquire the naming mechanisms of other mini program platforms in advance, so as to discover the other mini program platforms.

By parsing the manifest file, the mini program platform determines whether there is a service configured with a specific naming mechanism corresponding to a mini program platform in the manifest file. And if so, the method proceeds to 103, i.e., the scanned application may be considered as a host application integrated with the mini program platform.

In addition, when the host application integrates the mini program platform, the host application may decide whether to make the service accessible. If the service is accessible, the service of the mini program platform of the host application may be parsed when the profile is scanned, that is, the mini program platform integrated into the host application can be perceived; otherwise, the mini program platform integrated into the host application can not be perceived.

At 104, a service interface of the mini program platform is cached.

Usually after the host application integrates the mini program platform, the profile of the mini program platform declares its service as well as the service interface corresponding to the service (i.e., the service interface of the mini program platform). In other words, after parsing the profile for the application, when the declaration on the service of the mini program platform is acquired, the service interface of the mini program platform is also obtained and cached. In this step, the mini program platform may cache the service interface of the mini program platform of the host application integrated with the mini program platform in a specific directory of the mini program platform. What may be cached may comprise identification information of the host application and the service interface of the mini program platform of the host application.

Mini program platforms on the user equipment may execute the above-described procedure when launched and enable mutual discovery among mini program platforms, thereby perceiving the host applications where the other mini program platforms are located and the service interfaces of the mini program platforms, thus providing a basis for subsequent communication among mini program platforms.

It should be noted that 101˜104 may be executed by a discovery means in the mini program platform. The means may be located at the mini program platform, or may also be a functional unit such as a plug-in or Software Development Kit (SDK) located at the mini program platform.

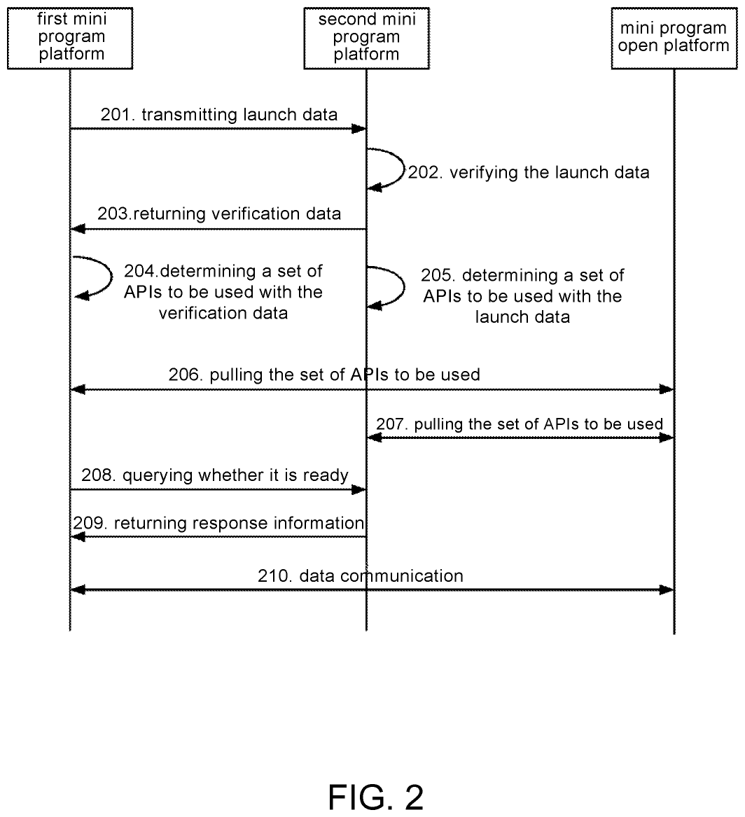

When one mini program platform is launched and discovers another mini program platform according to the flow shown in FIG. 1, the mini program platform may communicate with the other mini program platform according to the flow as shown in FIG. 2 as desired. In order to distinguish the two mini program platforms, a first mini program platform and a second mini program platform will be used respectively. It should be noted that the “first” and “second” in the embodiment are merely used to distinguish the mini program platforms, and are used neither to limit the functions, types, and other attributes of the mini program platforms, nor to represent ordering in any sense. As shown in FIG. 2, the method for communication between the two mini program platforms may comprise the following steps.

At 201, the first mini program platform transmits launch data to the second mini program platform.

The first mini program platform may transmit the launch data to the second mini program platform via a service interface of the mini program platform recorded and cached during discovery. The launch data may comprise information on a host application in which the first mini program platform is hosted and information on the first mini program platform and may further comprise a launch reason.

The information on the host application may comprise identification information of the host application (e.g., a package name of the host application) and may also comprise version information (e.g., a version number) of the host application. The information on the first mini program platform may comprise type information and version information (e.g., a version number) of the first mini program platform.

In the embodiments of the present invention, the identification information of the host application and the type information of the mini program platform may be used to uniquely identify the mini program platform.

The launch reason comprised in the above-described launch data may be, for example, to obtain data of a specific type, to obtain data of a specific user, to obtain data of a specific time and so on.

On one hand, the above-described launch reason is of informative purpose, i.e., to inform the second mini program platform of what the purpose of this communication is. On the other hand, the above-described launch reason is for verification, i.e., to enable the second mini program platform to verify this communication so as to determine whether to accept the communication initiated by the first mini program platform.

In the embodiments of the present invention, after a platform process (a physical process) of the first mini program platform is launched, the processing as shown in FIG. 1 and FIG. 2 are respectively performed by the platform process and a service interface process of the first mini program platform perform. The processing as shown in FIG. 2 may be performed by the service interface process of the second mini program platform when the platform process of the second mini program platform is not launched. Of course, the processing as shown in FIG. 2 may also be performed by the service interface process of the second mini program platform when the platform process of the second mini program platform is launched.

At 202, the second mini program platform performs verification with the received launch data.

This step is to perform verification with the launch data to determine whether to accept the communication with the first mini program platform. Specifically, verification may be performed according to at least one of the information on the host application, the information on the first mini program platform and the launch reason.

Performing verification according to the information on the host application may comprise verifying the host application based on a pre-configured whitelist, blacklist, etc. For example, the second mini program platform is pre-configured to reject communication from a specific host application. Verification may be performed based on rules related to the version of the host application, for example, rejecting communication from a host application whose version is higher or lower than a preset version.

Performing verification according to the information on the first mini program platform may also comprise verifying the mini program platform based on a pre-configured whitelist, blacklist, etc. For example, the second mini program platform is pre-configured to reject communication from a specific mini program platform. Verification may also be performed based on rules related to the version of the first mini program platform, for example, rejecting communication from the first mini program platform whose version is higher or lower than a preset version.

A launch reason for rejecting communication and a launch reason for allowing communication may be preconfigured. Performing verification according to the launch reason may comprise performing verification based on the configuration. For example, the second mini program platform is pre-configured to reject communication with a launch reason involving user privacy.

The specific policies that may be used for the above-described verification may be flexibly configured and will not be listed here exhaustively.

At 203, the second mini program platform returns verification data to the first mini program platform after determining to accept the communication.

In the embodiments of the present invention, the second mini program platform may determine whether to accept the communication based on verification information. If the communication is accepted, the second mini program platform returns the verification data to the first mini program platform. If the communication is not accepted, the second mini program platform may return a message for rejecting the communication or make no response to the first mini program platform.

The above-described verification data may comprise information on the host application in which the second mini program platform is hosted and information on the second mini program platform. The information on the host application may comprise identification information of the host application (e.g., a package name of the host application) and may also comprise version information (e.g., a version number) of the host application. The information on the second mini program platform may comprise type information and version information (e.g., a version number) of the second mini program platform.

In fact, a handshake process is accomplished via the above steps 201˜203. The following steps 204˜207 are used to achieve compatibility between Application Programming Interface (API) versions.

At 204, the first mini program platform determines a set of APIs to be used based on the verification data.

Usually, the type information and version information of the mini program platform can be used to uniquely identify the APIs it uses. Therefore, the first mini program platform may determine a version of a set of application programming interfaces corresponding to the second mini program platform based on the type information and version information of the second mini program platform contained in the verification data. A set of APIs corresponding to a minimal version out of a version of a set of APIs corresponding to the first mini program platform and a version of a set of the APIs corresponding to the second mini program platform is then determined as the set of APIs to be used.

At 205, the second mini program platform determines the set of APIs to be used based on the launch data.

The second mini program platform may determine a version of a set of application programming interfaces corresponding to the first mini program platform based on the type information and version information of the first mini program platform contained in the launch data. A set of APIs corresponding to a minimal version out of a version of a set of APIs corresponding to the first mini program platform and a version of a set of the APIs corresponding to the second mini program platform is determined as the set of APIs to be used.

At 206, the first mini program platform pulls the set of APIs to be used from a mini program open platform.

The mini program open platform is usually located at a server, which maintains the APIs for the mini program platforms. Different types and versions of mini program platforms correspond to different sets of APIs. Each of the mini program platforms may provide the types and version numbers of the mini program platforms that it requires to a mini program development platform. The mini program development platform will send the corresponding set of APIs to the mini program platform.

If the set of APIs to be used which is determined in step 204 already exists at the first mini program platform locally, the step 206 may be omitted.

At 207, the second mini program platform pulls the set of APIs to be used from the mini program open platform.

The step is implemented in a similar manner to 206 and will not be repeated herein. Similarly, if the set of APIs to be used which is determined in step 205 already exists at the second mini program platform locally, the step 207 may be omitted.

It should be noted that the order in which the above steps 204 and 205 are executed is not limited to what is shown in this embodiment, and that step 205 may be executed prior to step 204, or that steps 204 and 205 may be executed simultaneously. Similarly, the order in which the above steps 206 and 207 are executed is not limited to what is shown in this embodiment, and that step 207 may be executed prior to step 206, or that steps 206 and 207 may be executed simultaneously.

After compatibility between Application Programming Interface (API) versions is achieved, communication between the first mini program platform and the second mini program platform is started by the following steps.

At 208, the first mini program platform transmits, to the second mini program platform, information for querying whether it is ready.

At 209, the second mini program platform returns response information to the first mini program platform.

A handshake process is accomplished via the above 208˜209 by calling respective APIs.

If the first mini program platform does not receive the response information within a set time period, the first mini program platform may retransmit, to the second mini program platform, the information for querying whether it is ready. If the number of retransmission reaches a preset number and still no response information is received, this communication process ends. That is, this communication fails.

If the first mini program platform receives response information indicating that the second mini program platform is ready within the set time period, this handshake is successful and the flow proceeds with the subsequent steps for data communication.

If the first mini program platform receives response information indicating that the second mini program platform is not ready within the set time period, the first mini program platform may not retransmit, to the second mini program platform, the information for querying whether it is ready, until a certain time period elapses. When the number of retransmission reaches a preset number, then this communication process ends, i.e., this communication fails. Alternatively, if the first mini program receives response information indicating that the second mini program platform is not ready within the set time period, this communication process directly ends, i.e., this communication fails.

At 210, the first mini program platform communicates data with the second mini program platform.

The data is communicated mainly through calling APIs in service. This may be achieved by transferring first data with the called API, or transferring an access path to the second data in the called API, wherein the data amount of the first data is smaller than the data amount of the second data.

The above first data may be small data. For small data (e.g., text data), the small data may be transferred directly along with the called API.

The above second data may be big data. For big data (e.g. image, audio, etc.), an access path to a storage area in which the big data is stored may be transferred as a parameter of the called API. That is, the access path to the big data is transferred in the called API. The big data may be stored in a dedicated storage area, such as in an SD card. Each of the mini program platforms maintains its own access directory.

The above 201 to 210 may be executed by communication means in the mini program platform. The means may be located at the mini program platform, or may also be a functional unit such as a plug-in or Software Development Kit (SDK) located at the mini program platform.

It should be noted that in the communication flow as shown in FIG. 2, it may be the case that the first mini program platform discovers the second mini program platform according to the discovery procedure as shown in FIG. 1 after launching, and then actively transmits launch data to the second mini program platform for communication with the second mini program platform. It may also be the case that the second mini program platform performs the discovery procedure as shown in FIG. 1 after launching, but passively communicates with the first mini program platform after receiving the launch data from the first mini program platform. That is, each of the first mini program platform and the second mini program platform in the communication procedure as shown in FIG. 2 may have performed the discovery procedure as shown in FIG. 1 before performing the communication process as shown in FIG. 2.

In addition, in embodiments of the present invention, other discovery procedures may be used in addition to the discovery procedure as shown in FIG. 1 before the communication procedure as shown in FIG. 2 is performed. This application is not limited in this aspect.

As an example, the above process is described in a practical application scenario below.

It is assumed that applications installed on a mobile phone of a user comprise Application 1, Application 2, and Application 3, wherein Mini Program Platform 1 is integrated into Application 1, Mini Program Platform 2 is integrated into Application 2, and Mini Program Platform 3 is integrated into Application 3.

When Mini Program Platform 1 is launched along with Application 1, all applications installed on the user equipment are scanned. A manifest file of a scanned application is parsed to determine whether a service of a mini program platform is declared. That is, a specific naming mechanism is used to parse the service of the mini program platform in the manifest file of the scanned application, and identification information and service interface information of the host application is obtained from service information. For example, an installation package of an application includes a declaration as follows:

com.platform.app1.service.

The above declaration indicates that a mini program platform exists in Application 1 (app 1). Meanwhile, the service interface declared in the profile is obtained.

It is assumed that the information scanned and obtained by Mini Program Platform 1 is listed as follows:

Mini Program Platform 1—Application 1—Service Interface 1.

Mini Program Platform 2—Application 2—Service Interface 2.

Mini Program Platform 3—Application 3—Service Interface 3.

Each item in the above list of information is configured in a format of “mini program platform information—host application information—service interface information”. The above list is cached in a specified directory of Mini Program Platform 1. Since “Mini Program Platform 1—Application 1—Service Interface 1” is its own information, this item of information may be removed by Mini Program Platform 1 from the list.

The discovery procedure of Mini Program Platform 1 is completed so far.

If Mini Program Platform 1 wants to communicate with Mini Program Platform 2 which is discovered by Mini Program Platform 1, for example, to get a specific type of data from User A, then Mini Program Platform 1 calls Service Interface 2 to transmit launch data to Mini Program Platform 2. The launch data comprises identification information of Application 1, type information and version number of Mini Program Platform 1 and a launch reason.

Mini Program Platform 2 performs verification with the received launch data. Assuming that a particular type of data to be obtained of user A as indicated in the launch reason is private to the user, Mini Program Platform 2 may return information for rejecting the communication to Mini Program Platform 1, which indicates that the verification is not passed.

If the verification is passed, Mini Program Platform 2 may return to Mini Program Platform 1 the verification data, which comprises identification information of Application 2, type information and version number of Mini Program Platform 2. At this point, the handshake for launch is accomplished.

Each of Mini Program Platform 1 and Mini Program Platform 2 determines a set of APIs corresponding to a minimal version out of the versions of the sets of APIs corresponding to the two mini program platforms as the set of APIs to be used based on respective types and version numbers. If this set of APIs does not exist locally, then the set of APIs may be pulled from the mini program open platform. Thus, the compatibility between API versions is achieved.

Mini program Platform 1 transmits to Mini program Platform 2 information for querying whether it is ready, and Mini program Platform 2 returns response information indicating that it is ready to Mini program Platform 1. The second handshake is accomplished. If Mini Program Platform 2 returns response information indicating that Mini Program Platform 2 is not ready or makes no response to Mini Program Platform 1, this communication ends.

After the second handshake is accomplished, Mini Program Platform 1 and Mini Program Platform 2 may communicate data with each other by calling corresponding APIs. For small data, the small data may be transferred directly along with the called API. For big data, an access path to the big data may be transferred in the called API.

The above methods provided in the embodiments of the present invention may provide the following advantages.

1) The method for inter-mini program platform discovery provided in the present invention achieves mutual awareness among the mini program platforms when the mini program platforms are integrated into multiple host applications of the same user equipment at the same time.

2) The method for inter-mini program platform communication provided in the present invention achieves mutual communication among the mini program platforms when the mini program platforms are integrated into multiple host applications of the same user equipment at the same time.

3) The compatibility among APIs which can be used by mini program platforms in the process of mutual communication among mini program platforms is addressed.

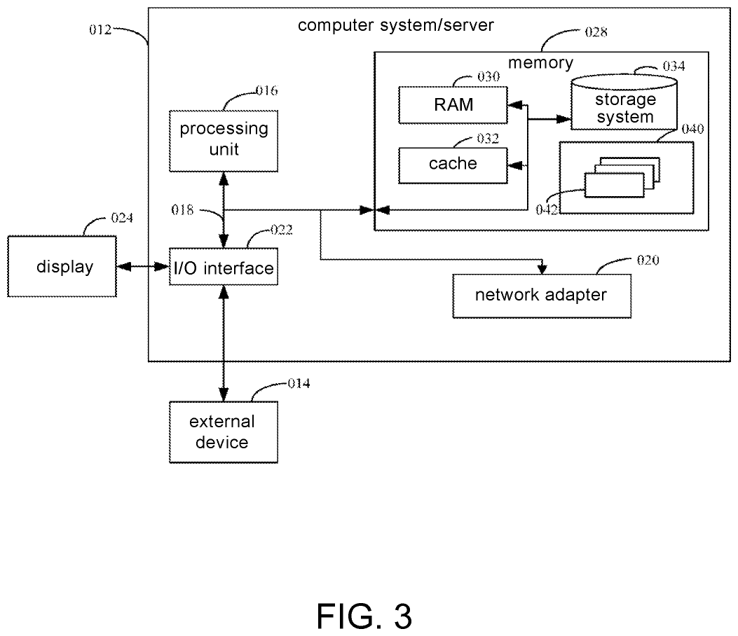

FIG. 3 shows a block diagram of an exemplary computer system/server 012 suitable for implementing the embodiments of the present invention. The computer system/server 012 shown in FIG. 3 is merely an example, and should not impose any limitation on the functions and scope of use of the embodiments of the present invention.

As shown in FIG. 3, the computer system/server 012 is embodied as a general-purpose computing device. Components of the computer system/server 012 may include but are not limited to one or more processors or processing units 016, a system memory 028, a bus 018 connecting different system components (including the system memory 028 and the processing unit 016).

The bus 018 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 012 typically includes a variety of computer system readable media. These media can be any available media that can be accessed by the computer system/server 012, including volatile and non-volatile media, removable and non-removable media.

The system memory 028 may include computer system readable media in the form of a volatile memory, such as a random access memory (RAM) 030 and/or a cache memory 032. Computer system/server 012 may further include other removable/non-removable, volatile/nonvolatile computer system storage media. By way of example only, the storage system 034 may be used to read and write non-removable, non-volatile magnetic media (not shown in FIG. 3 and is commonly referred to as a “hard drive”). Although not shown in FIG. 3, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 018 through one or more data media interfaces. The memory 028 may include at least one program product having a set of (e.g., at least one) program modules configured to perform the functions of the embodiments of the present invention.

A program/utility tool 040 having a set of (at least one) program modules 042 may be stored in, for example, the memory 028. Such program modules 042 include, but are not limited to, an operating system, one or more application programs, other programs modules and program data, each or some combination of these examples may include implementations of the network environment. The program module 042 generally performs functions and/or methods in the embodiments described in the present invention.

The computer system/server 012 can also communicate with one or more external devices 014 (e.g., a keyboard, a pointing device, a display 024, etc.). In the present invention, the computer system/server 012 can communicate with external radar devices, and can also communicate with one or more devices that enable users to interact with the computer system/server 012, and/or with any device (such as a network card, a modem, etc.) that enables the computer system/server 012 to communicate with one or more other computing devices. Such communication can be performed through an input/output (I/O) interface 022. Moreover, the computer system/server 012 can also communicate with one or more networks (such as a local area network (LAN), a wide area network (WAN), and/or a public network, such as the Internet) through a network adapter 020. As shown in the figures, the network adapter 020 communicates with other modules of the computer system/server 012 through the bus 018. It should be understood that although not shown in FIG. 3, other hardware and/or software modules may be used in conjunction with the computer system/server 012, including but not limited to: microcode, device drivers, redundant processing units, external disk drive arrays, RAID systems, tape drives and data backup storage systems.

The processing unit 016 performs various functional applications and data processing, such as implementing the method flows provided by the embodiments of the present invention, by executing programs stored in the system memory 028.

The above-mentioned computer program may be set in a computer storage medium, that is, the computer storage medium is encoded with a computer program, which when executed by one or more computers, causes the one or more computers to execute the method flow and/or apparatus operations shown in the above-described embodiments of the present invention. For example, the method flow provided in the embodiments of the present invention is executed by the above-described one or more processors.

With the development of time and technology, the meaning of media has become more and more extensive. The propagation method of computer programs is no longer limited to tangible media. Computer programs can also be downloaded directly from the network. Any combination of one or more computer-readable media may be used. The computer-readable media may be computer-readable signal media or computer-readable storage media. The computer-readable storage media may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, the computer-readable storage media may be any tangible media that contain or store programs that can be used by or in combination with an instruction execution system, apparatus, or device.

Computer-readable signal media may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal media may also be any computer-readable media other than computer-readable storage media, and the computer-readable media may send, propagate, or transmit a program for use by or in connection with an instruction execution system, apparatus or device.

Program code embodied on computer-readable media may be transmitted using any appropriate media, including but not limited to: wireless, wired, optical fiber cable, RF, etc., or any suitable combination of the foregoing.

Computer program code for performing the operations of the present invention may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

The above are only preferred embodiments of the present invention, and are not intended to limit the present invention. Any modification, equivalent replacement, and improvement made within the spirit and principle of the present invention should be included in the protection scope of the present invention.

1. A method for inter-mini program platform communication, the method comprising:
transmitting, by a first mini program platform, launch data to a second mini program platform, wherein the launch data comprises information on a host application in which the first mini program platform is hosted and information on the first mini program platform;
receiving verification data returned by the second mini program platform, wherein the verification data comprises information on a host application in which the second mini program platform is hosted and information on the second mini program platform;
determining a set of application programming interfaces to be used according to the verification data; and
communicating with the second mini program platform using the determined set of application programming interfaces.

2. The method as recited in claim 1, wherein the launch data further comprises a launch reason.

3. The method as recited in claim 1, wherein the information on the host application comprises identification information of the host application; and
the information on the mini program platform comprises type information and version information of the mini program platform.

4. The method as recited in claim 3, wherein determining the set of application programming interfaces to be used according to the verification data comprising:
determining a set of application programming interfaces corresponding to a minimal version out of a version of a set of application programming interfaces corresponding to the first mini program platform and a version of a set of application programming interfaces corresponding to the second mini program platform.

5. The method as recited in claim 4, wherein determining the set of application programming interfaces to be used according to the verification data further comprising:
pulling the set of application programming interfaces corresponding to the minimal version from a mini program open platform.

6. The method as recited in claim 1, wherein the communicating comprising:
transmitting, by the first mini program platform, to the second mini program platform, information for querying whether it is ready;
starting data communication with the second mini program platform after receiving response information from the second mini program platform.

7. The method as recited in claim 6, wherein the data communication comprising:
passing first data with an invoked application programming interface; or
passing an access path to second data in the invoked application programming interface;
wherein data amount of the first data is less than data amount of the second data.

8. A method for inter-mini program platform communication, the method comprising:
receiving, by a second mini program platform, launch data transmitted by a first mini program platform, wherein the launch data comprises information on a host application in which the first mini program platform is hosted and information on the first mini program platform;
returning verification data to the first mini program platform, wherein the verification data comprises the information on a host application in which the second mini program platform is hosted and information on the second mini program platform;
determining a set of application programming interfaces to be used according to the launch data; and
communicating with the first mini program platform using the determined set of application programming interfaces.

9. The method as recited in claim 8, wherein the launch data further comprises a launch reason.

10. The method as recited in claim 8, wherein the method further comprising:
performing, by the second mini program platform, verification with the launch data, and returning verification data to the first mini program platform after determining to accept the communication.

11. The method as recited in claim 8, wherein the information on the host application comprises identification information of the host application; and
the information on the mini program platform comprises type information and version information of the mini program platform.

12. The method as recited in claim 11, wherein determining the set of application programming interfaces to be used according to the verification data comprising:
determining a set of application programming interfaces corresponding to a minimal version out of a version of a set of application programming interfaces corresponding to the first mini program platform and a version of a set of application programming interfaces corresponding to the second mini program platform.

13. The method as recited in claim 12, wherein determining the set of application programming interfaces to be used according to the verification data further comprising:
pulling the set of application programming interfaces corresponding to the minimal version from a mini program open platform.

14. The method as recited in claim 8, wherein the communicating comprising:
receiving, by the second mini program platform, information transmitted by the first mini program platform for querying whether it is ready;
starting data communication with the first mini program platform after transmitting response information to the first mini program platform.

15. The method as recited in claim 14, wherein the data communication comprising:
passing first data with an invoked application programming interface; or
passing an access path to second data in the invoked application programming interface;
wherein data amount of the first data is less than data amount of the second data.

16. A device, comprising:
one or more processors; and
a storage means for storing one or more programs,
wherein the one or more programs, when executed by the one or more processors, cause the one or more processors to:
transmit, by a first mini program platform, launch data to a second mini program platform, wherein the launch data comprises information on a host application in which the first mini program platform is hosted and information on the first mini program platform;
receive verification data returned by the second mini program platform, wherein the verification data comprises information on a host application in which the second mini program platform is hosted and information on the second mini program platform;
determine a set of application programming interfaces to be used according to the verification data; and
communicate with the second mini program platform using the determined set of application programming interfaces.

17. A storage medium comprising computer-executable instructions, wherein the computer-executable instructions, when executed by a processor of a computer, cause the processor to:
transmit, by a first mini program platform, launch data to a second mini program platform, wherein the launch data comprises information on a host application in which the first mini program platform is hosted and information on the first mini program platform;
receive verification data returned by the second mini program platform, wherein the verification data comprises information on a host application in which the second mini program platform is hosted and information on the second mini program platform;
determine a set of application programming interfaces to be used according to the verification data; and
communicate with the second mini program platform using the determined set of application programming interfaces.

18. A device, comprising:
one or more processors; and
a storage means for storing one or more programs,
wherein the one or more programs, when executed by the one or more processors, cause the one or more processors to:
receive, by a second mini program platform, launch data transmitted by a first mini program platform, wherein the launch data comprises information on a host application in which the first mini program platform is hosted and information on the first mini program platform;
return verification data to the first mini program platform, wherein the verification data comprises the information on a host application in which the second mini program platform is hosted and information on the second mini program platform;
determine a set of application programming interfaces to be used according to the launch data; and
communicate with the first mini program platform using the determined set of application programming interfaces.
